(19) United States
(12) Patent Application Publication
(10) Pub. No.: US 2007/0232743 A1
(43) Pub. Date: Oct. 4, 2007

(54) Method of forming a vapor impermeable, repulpable coating for a cellulosic substrate and a coating composition for the same

(76) Inventors: Mario Laviolette, Saint-Augustin-de-Desmaures (CA); Tomi Jurkka Kimpimaki, Masku (FI); Tamal Ghosh, Ennetbaden (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/717,925

(22) Filed: Mar. 14, 2007

Related U.S. Application Data
(60) Provisional application No. 60/787,476, filed on Mar. 30, 2006.

(51) Int. Cl. D21H 17/00; C08K 9/04; C08K 3/34

(52) U.S. Cl. 524/445; 162/158; 162/168.1; 162/181.6; 162/135; 162/169; 524/449; 524/451

(57) ABSTRACT

The present invention relates to a method of forming a barrier coating effective in hindering the transmission of water vapor on a cellulosic substrate and to the coating formulation providing the same. The coating formulation requires at least two different synthetic polymers described herein and phyllosilicate particles.

This application claims benefit under 35 USC 119(e) of U.S. provisional application No. 60/787,476, filed Mar. 30, 2006, the contents of which are hereby incorporated by reference.

### FIELD OF THE INVENTION

The present invention relates to a method of forming a barrier coating on a cellulosic substrate. The coating is effective in hindering transmission of water vapor and does not interfere with repulpability of the coated cellulosic substrate.

The invention also concerns a coating formulation capable of providing the above-described qualities when applied to the cellulosic substrate.

### BACKGROUND

It is known in the art that a moisture vapor barrier property can be given to a paper web by means of coating the web with a polymeric latex having a wax emulsion added thereto. It is also known that these latex components may be selected from the group of conventional synthetic polymer latices such as styrene butadiene, acrylate, styrene acrylate and polyvinyl acetate latices. Examples of the above-described technology can be found in Great Britain Pat. No.1,593,331 and U.S. Pat. No 5,989,724.

According to U.S. Pat. No. 5,635,279 the amount of wax dispersion that may conventionally be added to a latex polymer is advantageously maximally about 10 wt %, while also significantly higher amounts are possible. The waxes most commonly used include paraffin wax, microcrystalline wax, polyethylene wax and a mixture of one of these waxes with at least one other type of wax. A coating formulation thus prepared gives an extremely hydrophobic coating. The addition of wax however causes printing problems as well as recycling difficulties. Coating compositions containing wax also make applications of a second coating difficult due to repulsion of the first coating. Thus complete continuous wax coating compositions may not provide uniform complete coverage of the paper.

The techniques taught in cited publications are capable of rendering desired barrier properties to the web. However, as the drying of the web leaving the coating section of the paper machine elevates the temperature of the coating applied to the paper web, the adherence risk of the coating in the winding of the paper web becomes so high as to exclude the use of above-mentioned conventional coating formulations when the goal is to achieve a uniform and defect-free coating. A further disadvantage is, that the high fraction of polymer latex in the coating formulation complicates the reuse of the coated paper in pulping.

U.S. Pat. No. 6,548,120 discloses the use of multiple polymeric coatings without wax on cellulosic substrates to effect an improvement in water vapor transmission rates (WVTR).

U.S. Pat. No. 6,531,196 and U.S. Pat. No. 6,545, 079 herein incorporated by reference disclose the use of lattices in combination with talc as coatings on a paper or paperboard to impede the transmission of water vapor, water and gases such as oxygen.

U. S. Pat. No. 5,897,411 discloses latex resins with mica.

U.S. Application Publication No. 2006/0122318 discloses the use of core-shell polymers in coatings for paper.

It is further known that starch, or polymers of natural origin may be added to a latex polymer during its preparation. For example, PCT Application no. 93/11300 discloses paper products coated with a polymer latex formed from a grafted starch which are easier to repulp than paper coated with pure polymer latices. While the technique can aid the pulping of the recycled paper product, it normally compromises water-vapor barrier properties of the product due to the hydrophilic character of the added starch.

### SUMMARY OF THE INVENTION

A method of forming a vapor impermeable, repulpable coating on a cellulosic substrate said method comprising the steps of:

applying an aqueous slurry to the cellulosic substrate

wherein the aqueous slurry comprises

i) at least one first synthetic polymer dispersion,

ii) a second polymer dispersion which second polymer is different than the first polymer and the second polymer comprises

an acrylic core shell polymer comprising an acrylic core polymer and an acrylic shell polymer surrounding the acrylic core polymer
and

iii) talc or phyllosilicate particles,

wherein the talc or phyllosilicate particles are at least about 20 percent by weight of the dry coating weight

and

drying said substrate.

The invention is further directed to an aqueous coating or sizing composition for paper, paperboard or a cellulosic substrate comprising at least components i) thru iii).

The coating in addition to providing a barrier against vapor also functions as a barrier to the passage of permeants selected from the group consisting of gases, liquids, greases, and oils.

The barrier coating of the invention is especially appropriate for blocking the penetration of water vapor.

The screening or blocking of water vapor presents special problems on paper and is related to the porosity of a coating. It is quite possible for a coating to be a good water barrier but poor water vapor barrier. Thus coated paper or board with a good Cobb value may not provide good water vapor screen especially when the coated paper or board is exposed to high relative humidity (˜90%) and high temperatures.

The thus formed and dried paper, paperboard or cellulosic article is also encompassed by the invention.

The paper or board coating gives surprising water vapor transmission rates (WVTR) without difficulties in recycling the coated cellulosic substrate.

### DETAILED DESCRIPTION OF THE INVENTION

A method of forming a vapor impermeable, repulpable coating on a cellulosic substrate said method comprising the steps of:

applying an aqueous slurry to the cellulosic substrate

wherein the aqueous slurry comprises

i) at least one first synthetic polymer dispersion,

ii) a second polymer dispersion which second polymer is different than the first polymer and the second polymer comprises

an acrylic core shell polymer comprising an acrylic core polymer and an acrylic shell polymer surrounding the acrylic core polymer
and

iii) talc or phyllosilicate particles,

wherein the talc or phyllosilicate particles are at least about 20 percent by weight of the dry coating weight

and

drying said substrate.

The invention is further directed to an aqueous coating or sizing for paper, paperboard or a cellulosic web composition comprising
i) at least one first polymer dispersion, wherein the first polymer is a synthetic polymer;
ii) a second polymer dispersion which second polymer is different than the first polymer and the second polymer comprises an acrylic core shell polymer comprising an acrylic core polymer and an acrylic shell polymer surrounding the acrylic core polymer
and
iii) talc or phyllosilicate particles,
wherein the talc or phyllosilicate particles are at least about 20 percent by weight of the dry coating weight.

Aqueous Slurry

Aqueous slurry for purposes of the invention means that the composition of the coating or sizing is dispersed or emulsified in a water-based medium.

Vapor Impermeable

Vapor impermeability of the coating or sizing on paper or board is measured using TAPPI method 464 for determining water vapor transmission rates (WVTR) at 90% relative humidity at 37.8° C. The lower the rate of transmission for water vapor, the better the water vapor barrier.

Repulpable

For purposes of the invention, a coated paper or board is repulpable when all its components disintegrate and may be used to make new board or paper. A good measure of the disintegration is the coating particle size after disintegration.

Good repulpability means that the coating layer allows the cellulose fibers to separate from each others and that the coating layer does not form agglomerates by binding several fibers together after repulping. At the same time the coating layer itself may not form or stay as large particles. A good measure for repulpability of a barrier coating is to compare residuals on a sieve that passes normal pigment coated broke.

First Synthetic Polymer

The first synthetic polymer dispersion is a polymer dispersion having about 10 to about 80 solids content and a glass transition point in the range of about −20 to about 70° C. Suitable polymer lattices are selected from the group of synthetic polymers consisting of styrene butadiene, styrene-acrylonitrile, styrene-acrylonitrile-butadiene, (meth)acrylates, styrene (meth)acrylates, polyvinyl chloride and polyvinyl acetate lattices and polymer dispersions made from a biologically degradable polymer, as well as mixtures of said synthetic polymer dispersions.

The first synthetic polymer for example is formed from at least the monomers styrene and butadiene.

The first synthetic polymer (latex or emulsion) comprises from about 15 to about 75 percent by weight, preferably about 20 to about 75 percent by weight of the dry coating weight, most preferably about 25 to about 75 percent by weight. For example, the polymer latex may comprise as much as about 70 percent by weight and as little as about 25 percent by weight. Additionally, the polymer latex may comprise from about 75 to about 30 percent by weight.

The first synthetic polymer may comprise a polymer formed from at least vinyl acetate and a C₁-C₄ ester of (meth)acrylic acid;

styrene and C₁-C₄ ester of (meth)acrylic acid; or C₁-C₄ ester of (meth)acrylic acid.

C₁-C₄ for purposes of the invention may be branched or unbranched for example methyl. ethyl, butyl, isobutyl, propyl, tert-butyl, sec-butyl or isopropyl.

Second Synthetic Polymer

Most preferably the second polymer comprises an acrylic core shell polymer which acrylic core polymer comprises
a polymer formed from a (meth)acrylate monomer or monomers and
a vinyl monomer or monomers to give a film-forming polymer,
wherein the film-forming polymer is formed in the presence of a stabilizing polymer,
wherein the stabilizing polymer is an acid-containing polymer formed by polymerizing a (meth)acrylic acid , maleic acid, or a mixture thereof and the stabilizing polymer forms the acrylic shell polymer.

Alternatively, the stabilizing polymer is formed from polymerizing (meth)acrylic acid, maleic acid, or a mixture thereof and a vinyl monomer or mixture of vinyl monomers other than the (meth) acrylic acid or maleic acid monomers and the stabilizing polymer forms the acrylic shell polymer.

A coated paper, paperboard or cellulosic article wherein the coating contains the above composition is also encompassed by the invention.

The coated paper or paperboard article not only provides a barrier against the passage of gaseous permeants but also provides a barrier from liquids, greases, and oils.

The coated paper or paperboard article coated with the inventive composition provides especially good water-vapor barrier properties with high degree of repulpability.

For purposes of the invention, the terms dispersion is interchangeable with the terms latex and emulsion. The polymeric dispersions are what the name implies, dispersions of discrete polymeric particles preferably in an aqueous media. The discrete polymeric particles are not substantially soluble in the water phase. The dispersion of the polymeric particles may be dispersed with the aid of emulsifiers, rheology improvers etc.

The said polymers form polymer latexes, i.e. polymer dispersions, which can be combined with talc particles and be applied onto board or paper as a coat in which dispersed polymer particles join one another as a polymer phase which binds the talc particles together.

Furthermore, polylactides, polyhydroxybutyrates/polyhydroxy-valerates, modified starches and other biopolymers which are compostable or entirely biodegradable can be mentioned as usable polymers which are especially advantageous.

The second polymer dispersion comprises an acrylic core shell polymer which acrylic core polymer comprises
i.) a polymer formed from a (meth)acrylate monomer or monomers and a vinyl monomer or monomers to give a film-forming polymer,
wherein the film-forming polymer is formed in the presence of a stabilizing polymer,
wherein the stabilizing polymer is an acid-containing polymer formed by copolymerizing a (meth)acrylic acid or maleic acid monomer or a mixture thereof and a vinyl monomer or mixture of vinyl monomers other than the (meth)acrylic acid or maleic acid monomer and forming the acrylic shell polymer.

The second polymer (core-shell polymer) makes up about 0.2 to about 20 percent by weight of the dry coating weight. For example, the second polymer makes up about 0.2 to about 15 percent by weight or more preferably about 0.2 to about 12 weight percent of the dry coating weight and most preferably about 0.2 to about 10 weight percent. For example about 0.2 to about 6 wt % of the dry coating weight is core-shell polymer. Alternatively, about 0.2 to about 3 or 2 wt. % will improve the WVTR of the coating.

An effective amount of the film-forming second polymer is prepared by emulsion or suspension copolymerizing of a (meth)acrylate monomer or monomers with a vinyl polymerizable monomer or monomers to give the film-forming property. The film-forming second polymer is preferably polymerized in the presence of a stabilizing polymer formed from an acid-containing polymer made by copolymerizing (meth)acrylic acid or maleic acid or mixtures thereof and a vinyl polymerizable monomer other than an acid containing monomer. The emulsion copolymerization of the film-forming polymer in the presence of the stabilizing polymer gives a core-shell particle emulsion. The core comprises the film-forming copolymer. The shell comprises the stabilizing polymer. The resulting core-shell particles form a stable aqueous emulsions, dispersions or suspensions.

The Film-Forming Second Polymer

Water based dispersions, emulsion or suspensions used in paper-based packaging applications ideally are film-forming or in other words provide a continuous pinhole-free polymeric film. One useful measure of the film-forming characteristics is the glass transition temperature (Tg) of the constituent polymers, an important measure of the flexibility of the barrier film. In packaging applications the barrier coating needs to be flexible to prevent crease and fold failures.

Another commonly used test for the film-forming characteristics is the “minimum film forming temperature” (MFFT) defined as the minimum temperature at which the dispersed polymer particles coalesce and start to form a continuous film.

The film forming copolymer formed from the combination of (meth)acrylate and vinyl monomers are capable of forming a copolymer of glass transition temperature (Tg) below 50° C., preferably below 30° C.

If the Tg is too low the coating may be tacky and be difficult to process in a manufacturing environment. Ideally the coating needs to have a right balance of brittleness and flexibility. Brittleness requires a higher Tg and helps with repulpability whereas low Tg gives flexibility. The final coating for the paper needs to be a coating with an overall Tg above room temperature in order to give the right balance of brittleness and flexibility.

The glass transition temperature (Tg) for a polymer is defined in the Encyclopedia of Chemical Technology, Volume 19, fourth edition, page 891, as the temperature below which (1) the transitional motion of entire molecules and (2) the coiling and uncoiling of 40 to 50 carbon atom segments of chains are both frozen. Thus, below its Tg a polymer would not exhibit flow or rubber elasticity.

The Tg of a polymer may be determined using Differential Scanning Calorimetry (DSC).

The MFFT temperature is determined by ASTM method D2354-98 and is properly applied to the dispersion. Thus the MFFT temperature applies to the coating system and includes other components not just the film-forming polymer referred to above.

For the purposes of the invention, all styrene based copolymers with alkyl(meth) acrylates giving a Tg of less than 50° C., preferably less than 30° C. could be used as the styrene-acrylate film-forming polymer.

The film-forming polymer is formed from (meth) acrylate monomer or monomers. The (meth) acrylate monomers are selected from the group of monomers consisting of n-butyl (meth)acrylate, 2-ethylhexyl (meth)acrylate, hexyl (meth)acrylate, isopropyl (meth) acrylate, decyl or lauryl (meth) acrylate, t-butyl (meth)acrylate, isobutyl(meth)acrylate, ethyl (meth)acrylate, glycidyl (meth) acrylate, hydroxyalkyl (meth) acrylates and dicarboxylic ester monomers such as maleates and propyl (meth)acrylate. The preferred (meth)acrylate monomers are n-butyl (meth) acrylate, 2-ethylhexyl (meth) acrylate and t-butyl (meth) acrylate or mixtures thereof.

The vinyl polymerizable monomer or monomers of the film-forming copolymer are selected from the group of monomers consisting of methyl (meth)acrylate, isobutyl (meth)acrylate, styrene, and styrene derivatives such as α-methyl styrene, alkylated styrene and mixtures thereof. The preferred vinyl polymerizable monomer or monomers are methyl methacrylate, styrene or alkylated styrene.

The vinyl polymerizable monomer for the film-forming copolymer is a monomer such as those described above which do not contain an acid functionality such as (meth)acrylic acid. In particular, styrene, α-methyl styrene and alkylated styrene are preferred.

The weight ratio of the (meth)acrylate monomers to vinyl polymerizable monomers in the film-forming polymer ranges from about 30/70 to about 70/30, preferably the weight ratio of (meth)acrylate monomers to vinyl polymerizable monomers is about 35/60 to about 60/35. Most preferably the weight ratio is about 40/60 to about 60/40 based on the total weight of the film-forming polymer.

For example, the film-forming (core of the core shell polymer) second polymers of the invention include

50 weight % n-butylacrylate and 50 weight % styrene,

45 weight % n-butyl acrylate and 55 weight % styrene,

40 weight % 2-ethylhexyl acrylate and 60 weight % styrene,

40 weight % 2-ethylhexyl acrylate and 30 weight % methyl methacrylate and 30 weight % styrene.

45% weight % 2-ethylhexyl acrylate and 55% weight % styrene.

Each of these examples gives a low Tg (under 50° C.) and are film-forming. For example, a 55/45 styrene 2-ethylhexyl acrylate give a Tg of ˜22° C.

The average molecular weight for the film-forming polymer ranges from about 150,000 to about 500,000 g/mol determined by GPC. Preferably the polymer has a molecular weight of about 200,000 to about 400,000 g/mol. More preferably the optimum molecular weight for the matrix polymer is about 200,000 to about 350,000 g/mol or about 200,000 to about 300,000 g/mol.

In order to obtain an aqueous dispersion from these vinyl monomers, it suffices to perform an emulsion or suspension polymerization of the monomers by well-known methods to produce a stable dispersion using hydrophilic catalysts, such as ammonium persulfate, potassium persulfate or aqueous hydrogen peroxide, or redox catalysts.

A mixture of vinyl monomers may be copolymerized in the emulsified or suspended state in the presence of anionic or nonionic surfactants to provide an emulsifying agent. In general, the use of low molecular weight surfactants is known to adversely affect the water and water vapor repellency of the coating formed, so that anionic polymeric stabilizers are preferred. These polymeric stabilizing agents may be exemplified by aqueous solutions of conventional alkali-soluble resins, such as acrylic or methacrylic or maleic copolymers containing carboxylic acid groups.

The Stabilizing Polymer

It is possible to form the stabilizing polymer entirely from (meth)acrylic acid. If this is the case, the Tg of the stabilizing polymer may be as high as about 150° C.

However, the preferred stabilizing polymer present during the polymerization of the film-forming polymer is made by polymerizing (meth)acrylic acid, and a vinyl polymerizable monomer other than an acid monomer to form a polymer of a glass transition temperature (Tg) that ranges from about 50° C. to about 150° C., preferably from about 70° C. to about 120° C. and most preferably the Tg ranges from about 80° C., to about 110° C.

The vinyl polymerizable monomer or monomers of the stabilizing polymer contain (meth)acrylic acid or maleic acid and a vinyl monomer other than the acid monomer. At least one of the vinyl monomers for the stabilizing polymer is preferably selected from the group consisting of styrene, alkylated styrene, α-methyl styrene, butyl (meth)acrylate, methyl (meth)acrylate and mixtures thereof.

The stabilizing polymer is an acid containing polymer made by copolymerizing (meth)acrylic acid or maleic acid, and a vinyl polymerizable monomer other than the (meth)acrylic acid and is formed from about 10 to about 50 weight % acrylic acid, methacrylic acid, maleic acid or mixtures thereof, preferably about 10 to about 45 weight % and about 90 to about 50 weight % of a vinyl polymerizable monomer other than the (meth) acrylic acid monomer or maleic acid, preferably about 90 to about 55 weight %. The monomer percentages are based on total weight of the polymer.

Examples of appropriate stabilizing polymers are

65% styrene and 35% acrylic acid;

43% isobutyl methacrylate, 43% methyl methacrylate and 14% acrylic acid;

43% butyl acrylate, 43% methyl methacrylate and 14% acrylic acid;

80% ethylene and 20% acrylic acid;

The salts of the stabilizing polymer may be any salt as long as the polymer maintains it's emulsifying properties. Preferably, the polymer is a volatile salt, for example an ammonium salt.

The shell polymer or stabilizing polymer has a molecular weight of about 6,000 to about 15,000 g/mol. Preferably the polymer has a molecular weight of about 6,000 to about 12,000 g/mol. Most preferably, the polymer has a molecular weight of about 6,000 to about 10,000 g/mol.

Generally the average particle size diameter of the second polymer particles is less than about 300 nanometers. Preferably the average particle size diameter is in the range of about 200 to 60 nanometers and especially between 150 and 60 nanometers. Average particle size is determined by a Coulter particle size analyzer according to standard procedures well documented in the literature.

A suitable technique for initiating the polymerization is, for instance, to elevate the temperature of the aqueous emulsion of monomer to above about 70 or 80° C. and then to add between 50 and 1000 ppm of ammonium persulfate or an azo compound such as azodiisobutyronitrile by weight of monomer. Alternatively, suitable peroxides, e.g. a room-temperature curing peroxide, or a photo-initiator may be used. It is preferably that the initiator be water-soluble.

It is preferred that the particles for the second polymer dispersion have a core-shell configuration in which the core comprises the film-forming polymer surrounded by a stabilizing polymeric shell. More preferably the particles comprise a core comprising the film-forming polymer and a shell comprising the water-soluble or partially water-soluble stabilizing polymer. It is particularly preferable that the shell of the water-soluble or partially water-soluble polymer is formed around the core of film-forming polymer and during polymerization.

The core-shell second polymer is provided in an aqueous emulsion and may include other additives such as thickening agents, defoaming or antifoaming agents, pigments, slip additives, release agents, fluorochemicals, starches, waxes and antiblocking agents. Components such as fluorochemicals, starches and waxes can also be added to improve oil, grease and other barrier properties such as water repellency and water vapor transmission barrier.

An optional wax component may also be added to the coating composition. The wax component may be selected from the group consisting of paraffin wax, candelilla, carnauba, microcrystalline wax, polyethylene wax and a blend of two or more of said waxes.

It is preferable, however, that no wax is added to the barrier coating.

Starches, lactic-acid based and polyhydroxybutyrate/valerate-based polymer or polyesters of various organic di- or tri-acids with alcohols having functionality of two or higher, in which case the said acids may be, for example, adipic, maleic and citric acid and the alcohols, for example, ethylene, propylene and neopentyl glycol and pentarythritol and glycerol may also be added to the coating composition.

Typical sources of starches include cereals, tubers, roots, legumes and fruits. Native sources can be corn, pea, potato, sweet potato, banana, barley, wheat, rice, sago, amaranth, tapioca, arrowroot, canna, and sorghum.

The dry weight ratio of the first polymer to second polymer in the paper or paperboard coating may be from about 50:1 to about 1:50. Preferably, the first polymer will make up a larger proportion of the mixture. Thus the dry weight ratio of the first polymer to the second polymer in the paper or paperboard coating will range from about 50:1 to about 2:1, about 20:1 to about 2:1 or 15:1 to about 2:1 or 15:1 to about 4:1 or even about 12:1 to about 6:1.

The total weight of the first and second polymer dispersions comprise about 10 to 80 percent by weight the total dry weight of the coating, about 20 percent to about 70% by weight or about 25 to about 70% by weight. For example, about 30 to about 65, or about 35 to about 60% by weight is possible.

Generally, the second polymer dispersion (core-shell polymer) will make up no more than about 15 percent by weight of the first polymer dispersion; preferably no more than about 10 percent by weight of the first polymer dispersion; and most preferably no more than about 8 percent by weight. All percents by weight are based on dry weights of the polymers.

The coating formulation according to the invention improves the protection of the paper web against water vapor transmission (WVTR); simultaneously the coating smooths any possible roughness in the paper web, thus reducing the consumption of another kind of coating to be subsequently applied to the pre-coated web.

The coating mixture prepared according to the invention can be used in coated paper grades principally including different types of packages and wrappers which have to exhibit certain barrier properties against moisture and water vapor penetration and often also protection against oil and grease penetration as well as transmission of gases such as oxygen, for instance.

According to another aspect of the invention, the coating mixture can also be applied on a polymer film known to cause sticking of adjacent web surfaces, whereby the winding of the coated paper without the risk of web adherence to the adjacent surface becomes possible.

The novel coating formulation may also be used for pretreating a paper web which subsequently is coated by another type of coating intended to render other kinds of properties to the web such as the suitability to be heat sealed.

According to a preferred embodiment of the invention, the proportion of talc or phyllosilicate particles in the coating mixture is 20-70 percent of solids in the dry coating mixture. Preferably, the talc or phyllosilicate is at least a minimum of about 30 percent by weight in the dry coating mixture and ranges from about 30 to about 70 percent by weight of the dry coating mixture. For example, ranges from about 45 percent by weight to about 70 percent by weight, about 50 to about 70 percent by weight and ranges from 60 percent by weight to about 70 percent by weight are also possible.

The talc may be about 90 to about 100 percent purity and a particle size of about 90 percent below 50 μm as described in U.S. Pat. No. 6,545,079 incorporated by reference.

Suitable phyllosilicates or talc might be mica, talc, silica, clay or kaolin. The mica employed in the present invention may be a natural mica such as muscovite, paragonite, jphlogopite, biotite, and syrian mica or a synthetic mica such as fluorine-contained phlogopite, fluorine/silicone-contained mica, and taeniolite.

The coating mixture formulation used in the invention, in which the above-described polymer dispersions (first and second polymer dispersions) and particles of talc are the main components, may be additionally complemented with other pigment or mineral particles, for instance for increasing the opacity of the coating mixture. The addition of waxes and colors is also another possibility to adjust the properties of the coating composition of the invention.

The amount of other pigment or mineral components can be increased up to 30 wt. % of the coating mixture solids. Clay, calcium carbonate, titanium dioxide, gypsum and organic pigments can be used as such additional components. The amount of colors can vary from 0 to 5 percent of the overall coating mixture solids.

When the coated paper or paperboard is used for food packaging, the packaging may also contain additives which protect the food from the harmful effects of ultraviolet light such as ultraviolet absorbers. The packaging may further contain oxygen scavengers or antioxidants to protect the food from oxidation.

The surface energy of the polymer film achieved using the coating composition according to the invention can be further regulated by a reaction with siloxanes and poly siloxanes. This can be used for regulating for instance the printability of the film. Also adhesion properties towards different surfaces can be effected by using said further components in the coating compositions.

The invention can be implemented in several ways, for example, the talc particles in an aqueous phase using only an anti foaming agent and sodium hydroxide may be mixed with both the first and second polymer dispersion(s). Alternatively the first and second polymer dispersions(s) may be added to the talc slurry. Generally, it is preferable that the first and second polymers are dispersed in an aqueous media before being combined with the aqueous talc slurry. The talc may be combined with the first polymer dispersion than mixed with the second polymer dispersion then applied to the paper or board.

The talc may be dispersed using typical dispersing agents before being combined with the first and second polymers.

The talc may be blended at a relatively high pH. High pH for the purposes of the invention means greater than about 9.

The term coating is in the present context used when reference is made to a formulation suitable for application to a paper or board web so as to act on a paper product as a coating with barrier properties against the transmission of water, water vapor and oxygen, among others.

The coating may also encompass a surface sizing which is conventionally carried out by means of a sizing device, such as a size press, flitted in the drying section of a paper machine or the like. After the application of the size, the web is directed through the latter part of the drying section, where the size dries. Surface sizing can also be carried out by means of a separate coating unit, for example, when the machine does not have a separate surface sizing unit.

The coating mixture according to the invention can be applied to the web using conventional coating apparatus developed for coating a paper or board web. Advantageously, the applied coat weight is 1-50 g/m² as the solids of the coating mixture.

Substrates employed in the invention include a variety of coated and uncoated paper and paperboard, including bleached or unbleached, hardwood or softwood, virgin or recycled, coated or uncoated forms of paper or paperboard. The basis weight of the substrate ranges from 20 to 600 g/m². Preferable range of basis weight is about 50 to about 350 g/m² or about 100 to about 250 g/m².

The water based coatings of the invention have dry coating weights in the range of about 1 to about 50 g/m². Preferably the coatings weight varies from about 5 to about 40 g/m². Especially preferred coatings weights will vary from about 20 to about 45g/m² or from about 20 to about 40 g/m².

Drying temperatures and line speeds are dictated by the drying characteristics of specific coating formulations, for example the percent solids content, substrate basis weight and adsorbency, and equipment characteristics.

Of course, more than one coating may be applied to the paper or paperboard. Preferably more than one coating is applied for example 2 coats. This will generally increase the barrier properties of the paper or paperboard. Normally the total coatings weight values will vary as above from about 1 to about 30 g/m².

The water-based emulsion coatings of this invention may be applied to the surface of the substrate by any method of coating suitable for water-based coatings. Examples of suitable surface treatment methods include various conventional coating methods such as air knife coating, blade coating, metering roll coating, rod coating, curtain coating, spray coating, injet printing, flexo and gravure coating, size press applications and water box.

Generally some type of elevated temperature drying will be required in order to dry the water based emulsion coatings at an acceptable production speed. Suitable drying methods include hot air drying, infrared drying, direct flame drying and drying by contact with a steam roll.

The following examples describe certain embodiments of this invention, but the invention is not limited thereto. It should be understood that numerous changes to the disclosed embodiments can be made in accordance with the disclosure herein without departing from the spirit or scope of the invention. These examples are therefore not meant to limit the scope of the invention. Rather, the scope of the invention is to be determined only by the appended claims and their equivalents. In these examples all parts given are by weight unless otherwise indicated.

### EXAMPLE 1

Talc Dispersion

Talc, either as a powder or granulated, is slurried in water according to the following formulation: 1585.6 g of water, 4.1 g of sodium polyacrylate and 16.2 g of sodium carboxymethyl cellulose are weighed into a dispersion vessel. High rotation speeds are used in the dispersion in order to break up talc agglomerates. Talc is added to the mixture gradually, in total 2700.0 g. Halfway through the adding of the talc, a further 4.1 g of sodium polyacrylate and 2.4 g of sodium hydroxide is added. The dispersing vessel is equipped with a cooling mantle, and the cooling of the slurry is started at 20 min from the ending of the talc adding step. Thereafter the dispersing is continued for another 20 min. The product obtained is a talc slurry having a solids content of 63.0% and a viscosity of 200 mPas, measured by using a Brookfield LVT viscometer with measuring head No. 3, at a rotation speed of 100 r/min. The final formulation is obtained by mixing the talc slurry with a polymer latex.

### EXAMPLE 2

Talc Dispersion with First Polymer Dispersion

Talc, either as a powder or granulated, is slurried in a polymer latex, according to the following formulation: 181.1 g of water, 1700.0 g of a polymer latex based on styrene butadiene (solids content 50%, second order transition temperature +20° C.), 3.4 g of sodium hydroxide and 1.7 g of organomodified siloxane are weighed into a dispersion vessel. High rotation speeds are used in the dispersing in order to break up any talc agglomerates. Talc is added to the mixture gradually, in total 1700.0 g. The dispersion vessel is equipped with a cooling mantle, and the cooling of the slurry is started at 20 min from the ending of the talc adding step. Thereafter the dispersing is continued for another 20 min. The product obtained is a coating compound having a solids content of 68.0% and a viscosity of 1150 mPas measured by using a Brookfield LVT viscometer with measuring head No. 4, at a rotation speed of 100 r/min.

Formation of the acrylic core shell polymer (second polymer dispersion)

### EXAMPLE 3

Butyl acetate (250 g) is charged to a reactor and heated to reflux (125° C.). tert-Butyl perbenzoate (7.8 g) is added to the reactor. A monomer feed consisting of styrene (162.5 g) and glacial acrylic acid (87.5 g) is prepared. An initiator feed consisting of tert-butyl-perbenzoate (23.4 g) is prepared. The monomer feed is added to the reactor within 5 hours and the initiator feed is added to the reactor within 5.5 hours. Once the feeds are completed, the reaction mixture is held for a further 1 hour at 125° C. A mixture of 20% by weight aqueous ammonia (100 g) and water (700 g) is added to the reactor whilst distilling off butyl acetate. The distillate is split and the water returned to the reactor and the butyl acetate to the receiver. The temperature of the reaction mixture falls to 93° C. during distillation and rises to 100° C. when all the butyl acetate has been removed. When distillation is complete, the reaction mixture is cooled to below 40° C., the obtained solution of 65/35 (w/w) styrene/acrylic acid, ammonium salt is adjusted to 25% by weight solid content and pH 9.0.

The 25% by weight aqueous solution of styrene/acrylic acid, ammonium salt copolymer (576 g) and water (71 g) is charged to a reactor, heated to 85° C. and degassed with nitrogen for 30 minutes. Ammonium persulfate (0.5 g) is added. A monomer feed consisting of styrene (184.8 g) and 2-ethylhexyl acrylate (151.2 g) is prepared. An initiator feed consisting of ammonium persulfate (1.5 g) and water (15.0 g) is prepared. The monomer feed is added to the reactor within 3 hours and the initiator feed is added to the reactor within 4 hours. The temperature of the reaction mixture is kept at 85° C. during polymerisation. Once the feeds are completed, the contents is held for a further 1 hour at 85° C. before being cooled to below 40° C. and Acticide® LG, a biocide containing chlorinated and non-chlorinated methyl isothiazolones, (0.9 g) is added. The obtained core shell polymer consists of 70 weight parts 55/45 (w/w) styrene/2-ethylhexyl acrylate copolymer, which functions as the core polymer, and 30 weight parts 65/35 (w/w) styrene/acrylic acid, ammonium salt copolymer, which functions as the shell polymer. The core shell polymer is obtained as an aqueous emulsion having a solid content of about 46% (w/w), a pH of 8.5 and a viscosity at 25° C. (Brookfield 20 rpm) of 700 mPa×s.

The particle size of the core-shell is typically about 80 nm to about 120 nm.

### EXAMPLE 4

First Polymer Dispersion with Talc as in Example 2+Second Polymer Dispersion as in Example 3

The 55 to 58 wt. % solids is formed as in example 2 above. The slurry is combined with the second polymer dispersion formed in example 3 at various weight percents. Wax is also included in several of the formulation before being applied as a paper coating. Table 1 correlates formulations with sample numbers and resulting BROOKFIELD viscosities (cP). The BROOKFIELD viscosity is measured at 22° C. using a #3 spindle at 100 rpm.

TABLE 1

| | Total Solids | Ex. 2/Ex. 3/Wax¹ | Viscosity |
|---|---|---|---|
| Sample # | (% w/w) | (% w/w) | (cP) |
| Sample 1 | 56.5% | 100/0/0 | 533 |
| Sample 2 | 56.2 | 95/5/0 | 385 |
| Sample 3 | 56.1 | 97/3/0 | 430 |
| Sample 4 | 56.4 | 99/1/0 | 492 |
| Sample 5 | 55.3 | 90/10/0 | 362 |
| Sample 6 | 54.9 | 90/5/5 | 246 |
| Sample 7 | 56.1 | 97/1.5/1.5 | 526 |

¹The weight (w/w) are based on a 56.5 wt. % talc and latex solutions formed as in example 2 and a 46 wt. % core-shell polymer solution.

The above samples 1-7 are applied to liner paper of 26 lb/1000 Ft² (˜125 g/m²) in two rod coatings. The coating weights for the first coating is approximately 20 to 22 g/m² with a second coating of about 8 to 10 g/m². The coating weights are determined by drying the coated sheet at 105° C. for 30 seconds. The water vapor transmission rates (WVTR) are determined under 90% R.H. at 37.8° C. under TAPPI method 464.

Repulpability is determined by cutting up the coated paper into 1 in² pieces and soaking in demineralized water; then subjecting to shear until the pulp is consistent; diluting to 0.30 wt % solids; forming handsheets from the pulp and drying. The dried paper is then evaluated using the transmitted light plate and the direct phosphorescent light to determine the average size of the coating particles. The smaller the coating particle size, the better the repulpability of the original coating.

The ACCU DYNE Test™ is a method of determining the surface energy of the test sample. The surface energy is determined by drawing an ACCU DYNE Test™ marker pen across the surface of the test sample. If the ink swath holds for one to three seconds before losing its integrity, the dyne level of the marker closely matches that of the sample. The ACCU DYNE test marker pens used have 16 levels (30 to 60 dynes/cm).

TABLE 2

| | | WVTR | | |
|---|---|---|---|---|
| | | (g water/ | ACCU DYNE | Repulpability |
| | Coating weight | m² for | Test ™ | (Particle |
| Sample # | (g/m²) | 24 hr) | (dynes/cm) | size) ((in)²) |
| Sample 1 | 21 + 10 | 94 ± 9 | 44-46 | 3/64 |
| Sample 2 | 20 + 10 | 52 ± 2 | 42-44 | 1/16 |
| Sample 3 | 21 + 9 | 57 ± 4 | 42-44 | 3/64 to 1/16 |
| Sample 4 | 20 + 10 | 62 ± 2 | 42-44 | 3/64 to 1/16 |
| Sample 5 | 22 + 8 | 56 ± 3 | 42-44 | 3/64 to 1/16 |
| Sample 6 | 20 + repulsion | — | 30 | — |
| Sample 7 | 20 + 11 | 52 ± 4 | 30 | 3/64 |

What is claimed is:

1. A method of forming a vapor impermeable, repulpable coating on a cellulosic substrate said method comprising the steps of:
applying an aqueous slurry to the cellulosic substrate
wherein the aqueous slurry comprises
i) at least one first synthetic polymer dispersion,
ii) a second polymer dispersion which second polymer is different than the first polymer and the second polymer comprises
an acrylic core shell polymer comprising an acrylic core polymer and an acrylic shell polymer surrounding the acrylic core polymer
and
iii) talc or phyllosilicate particles,
wherein the talc or phyllosilicate particles are at least about 20 percent by weight of the dry coating weight
and
drying said substrate.

2. A method according to claim 1, wherein the talc or phylosilicate particles are selected from the group consisting of natural mica, synthetic mica, talc, silica, clay and kaolin.

3. The method according to claim 1, wherein said coating provides a barrier against the passage of permeants selected from the group consisting of liquids, greases, and oils.

4. The method according to claim 1 wherein the first synthetic polymer dispersion comprises a synthetic polymer selected from the group consisting of styrene butadiene, styrene-acrylonitrile, styrene-acrylonitrile-butadiene, (meth)acrylates, styrene (meth)acrylates, polyvinyl chloride and polyvinyl acetate.

5. The method according to claim 4, wherein the first synthetic polymer is formed from at least the monomers styrene and butadiene.

6. The method according to claim 4, wherein the first synthetic polymer is formed from at least
vinyl acetate and an C₁-C₄ ester of (meth)acrylic acid;
styrene and a C₁-C₄ ester of (meth)acrylic acid;
or a C₁-C₄ ester of (meth)acrylic acid.

7. The method according to claim 1 wherein the acrylic core shell polymer comprises
a polymer formed from a (meth)acrylate monomer or monomers and a vinyl monomer or monomers to give a film-forming polymer, wherein the film-forming polymer is formed in the presence of a stabilizing polymer,
wherein the stabilizing polymer is an acid-containing polymer formed by polymerizing a (meth)acrylic acid , maleic acid, or a mixtures thereof and forms the acrylic shell polymer.

8. The method according to claim 1 wherein the acrylic core shell polymer comprises
a polymer formed from a (meth)acrylate monomer or monomers and a vinyl monomer or monomers to give a film-forming polymer, wherein the film-forming polymer is formed in the presence of a stabilizing polymer,
wherein the stabilizing polymer is an acid-containing polymer formed by polymerizing a (meth)acrylic acid, maleic acid, or a mixtures thereof and a vinyl monomer or mixture of vinyl monomers other than the (meth) acrylic acid, maleic acid monomers and forms the acrylic shell polymer.

9. The method according to claim 7, wherein the film-forming polymer is formed from (meth) acrylate monomer or monomers wherein the monomers are selected from the group consisting of n-butyl (meth)acrylate, 2-ethylhexyl (meth)acrylate, hexyl (meth)acrylate, isopropyl (meth) acrylate, decyl or lauryl (meth) acrylate, t-butyl (meth)acrylate, isobutyl(meth)acrylate, ethyl (meth)acrylate, glycidyl (meth) acrylate, hydroxyalkyl (meth) acrylates, dicarboxylic ester monomers and propyl (meth)acrylate.

10. The method according to claim 7, wherein the film-forming vinyl monomer or monomers are selected from the group of monomers consisting of methyl (meth)acrylate, isobutyl (meth)acrylate, styrene, α-methyl styrene, alkylated styrene and mixtures thereof.

11. The method according to claim 8, wherein the vinyl polymerizable monomer of the stabilizing polymer is at least one of the vinyl monomers selected from the group of vinyl monomers consisting of styrene, alkylated styrene, α-methyl styrene, butyl (meth)acrylate, methyl (meth)acrylate and mixtures thereof.

12. The method according to claim 1, wherein the talc or phyllosilicate is about 30 to about 70 wt % of the total weight of the coating.

13. The method according to claim 1, wherein the total weight of the first and second polymer dispersions comprises about 10 to about 80 percent by weight the total dry weight of the coating.

14. A method according to claim 1, wherein the dry weight ratio of the first and second polymer dispersions is about 50:1 to about 1:50.

15. An aqueous coating or sizing for paper, paperboard or a cellulosic web composition comprising
i) at least one first polymer dispersion, wherein the first polymer is a synthetic polymer;
ii) a second polymer dispersion which second polymer is different than the first polymer and the second polymer comprises an acrylic core shell polymer comprising an acrylic core polymer and an acrylic shell polymer surrounding the acrylic core polymer
and
iii) talc or phyllosilicate particles, wherein the talc or phyllosilicate particles are at least about 20 percent by weight of the dry coating weight.

16. The coating or sizing according to claim 15, wherein the acrylic core shell polymer comprises an acrylic core which comprises
a copolymer formed from a (meth)acrylate monomer or monomers and a vinyl monomer or monomers to give a film-forming copolymer,
wherein the film-forming copolymer is formed in the presence of a stabilizing copolymer,
wherein the stabilizing copolymer is an acid-containing copolymer formed by copolymerizing at least (meth)acrylic acid , maleic acid or mixtures thereof, and a vinyl monomer or mixture of vinyl monomers other than the (meth) acrylic acid monomer and forming the acrylic shell polymer.

17. The coating or sizing according to claim 16, wherein the (meth) acrylate monomer or monomers are selected from the group of monomers consisting of n-butyl (meth)acrylate, 2-ethylhexyl (meth)acrylate, hexyl (meth)acrylate, isopropyl (meth) acrylate, decyl or lauryl (meth) acrylate, t-butyl (meth)acrylate, isobutyl(meth)acrylate, ethyl (meth)acrylate, glycidyl (meth) acrylate, hydroxyalkyl (meth) acrylates, dicarboxylic ester monomers and propyl (meth)acrylate.

18. A coating or sizing composition according to claim 16, wherein the vinyl monomer or monomers of the film-forming copolymer are selected from the group of monomers consisting of methyl (meth)acrylate, isobutyl (meth)acrylate, styrene, α-methyl styrene, alkylated styrene and mixtures thereof.

19. A coating or sizing composition according to claim 16, wherein the film-forming polymer has a Tg of about 50° C. or less.

20. A coating or sizing composition according to claim 16, wherein the weight ratio of the (meth)acrylate monomers to vinyl polymerizable monomer in the film-forming polymer ranges from about 30/70 to about 70/30 based on the total weight of the film-forming polymer.

21. A coated paper or paperboard article wherein the coating comprises a composition according to claim 16.
